(19) United States
(12) Patent Application Publication
(10) Pub. No.: US 2013/0154937 A1
(43) Pub. Date: Jun. 20, 2013

(54) APPARATUS AND METHOD FOR PROVIDING CUSTOMIZED KEYBOARD USER INTERFACE

(71) Applicant: Juyoung PARK, Daejeon-si (KR)

(72) Inventor: Juyoung PARK, Daejeon-si (KR)

(73) Assignee: Electronics and Telecommunications Research Institute, Daejeon-si (KR)

(21) Appl. No.: 13/619,149

(22) Filed: Sep. 14, 2012

(30) Foreign Application Priority Data
Dec. 20, 2011 (KR) 10-2011-0138654

(51) Int. Cl. G06F 3/02

(52) U.S. Cl. 345/168

(57) ABSTRACT

Provided are an apparatus and method for providing customized keyboard user interfaces (UIs) to various users. A terminal device generates keyboard UI request information for requesting keyboard UI data which is to be set in a user input device, transmits the keyboard UI request information to a keyboard UI providing server, receives keyboard UI data determined based on the keyboard UI request information from the keyboard UI providing server, and sets the received keyboard UI data in the user input device.

### CROSS-REFERENCE TO RELATED APPLICATION

This application claims the benefit under 35 U.S.C. §119(a) of a Korean Patent Application No. 10-2011-0138654, filed on Dec. 20, 2011, the entire disclosure of which is incorporated herein by reference for all purposes.

### BACKGROUND

1. Field

The following description relates to user interface technology, and more particularly, to an apparatus and method for dynamically providing a user interface.

2. Description of the Related Art

Various researches have been conducted in Korea as well as in advanced countries to make information technology (IT) accessible to the old and the disabled who have difficulty using a general keyboard due to weak eyesight or physical disabilities, and relevant products have been produced.

In these researches, input screens have been reinforced for weak-sighted people, and customized keyboards that meet various needs have been manufactured. Examples of the keyboards include large keyboards for old people, symbol keyboards for physically disabled people, and simplified keyboards for people with learning disabilities.

Conventional terminal input devices are developed in the form of special keyboard products for a few users with different disabilities. Thus, they are very expensive. In addition, since a conventional terminal input device is a special keyboard only for each individual, the individual always has to carry his or her keyboard to use public devices that normal people and other disabled people use.

### Citation List

### Patent Literature

1) Korean Patent Publication No. 10-2011-0035724
Publication date: Apr. 6, 2011
Applicant: Pantech Corporation
Title of the Invention: Method and Apparatus for Providing Virtual Keyboard.

### SUMMARY

It is an objective of the present invention to provide a customized keyboard user interface (UI) for each user in order to make information technology (IT) more accessible to various users such as the old and the disabled who have difficulty using a general keyboard due to weak eyesight or physical disabilities.

In one general aspect, there is provided a terminal device including: a keyboard UI processing unit generating keyboard UI request information for requesting keyboard UI data which is to be set in a user input device; a network interface unit communicating with a keyboard UI providing server and the user input device, transmitting the keyboard UI request information to the keyboard UI providing server, and receiving keyboard UI data determined based on the keyboard UI request information from the keyboard UI providing server; and a keyboard UI setting unit setting the received keyboard UI data in the user input device.

In another aspect, there is provided a keyboard UI providing server including: a keyboard UI storage unit storing a plurality of keyboard UI data; a user profile management unit managing a user profile which indicates keyboard UI identification information corresponding to user identification information of each of a plurality of users; a keyboard UI management unit selecting keyboard UI data, which is to be sent to a terminal device, from the keyboard UI data based on keyboard UI request information received from the terminal device and using the user profile; and a network management unit transmitting the selected keyboard UI data through a network, wherein the keyboard UI request information includes the user identification information

In another aspect, there is provided a user input device including: a terminal interface configured to communicate with a terminal device; a keyboard UI providing unit receiving keyboard UI data from the terminal device through the terminal interface and managing the keyboard UI data; and a user input unit displaying the keyboard UI data and receiving a user input signal.

In another aspect, there is provided a keyboard UI providing method of a terminal device which is connected to a keyboard UI providing server and a user input device through a network. The method includes: generating keyboard UI request information for requesting keyboard UI data which is to be set in the user input device; transmitting the keyboard UI request information to the keyboard UI providing server; receiving keyboard UI data corresponding to the keyboard UI request information from the keyboard UI providing server; and setting the received keyboard UI data in the user input device.

Other features and aspects will be apparent from the following detailed description, the drawings, and the claims.

### BRIEF DESCRIPTION OF THE DRAWINGS

FIG. 1 is a diagram illustrating the configuration of a system for providing a customized keyboard user interface (UI) according to an embodiment of the present invention;

FIG. 2 is a block diagram illustrating an example configuration of a terminal device to which a user input device of FIG. 1 is connected;

FIG. 3 is a block diagram illustrating an example configuration of a keyboard user interface (UI) providing server of FIG. 1;

FIG. 4 is a diagram illustrating an example configuration of keyboard UI data stored in a keyboard UI storage unit of the keyboard UI providing server of FIG. 3;

FIG. 5 is a diagram illustrating user profile information managed by the keyboard UI providing server of FIG. 3;

FIG. 6 is a block diagram illustrating an example configuration of the user input device of FIG. 1;

FIG. 7 is a block diagram illustrating an example configuration of a keyboard UI development server of FIG. 1;

FIG. 8 is a diagram illustrating a keyboard UI corresponding to keyboard UI data received by the terminal device from the keyboard UI providing server and a keyboard UI displayed on the user input device according to an embodiment of the present invention; and

FIG. 9 is a flowchart illustrating a method of providing a customized keyboard UI according to an embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The invention is described more fully hereinafter with reference to the accompanying drawings, in which exemplary embodiments of the invention are shown. Descriptions of well-known functions and constructions are omitted to increase clarity and conciseness. Also, the terms used in the following description are terms defined taking into consideration the functions obtained in accordance with the present invention, and may be changed in accordance with the option of a user or operator or a usual practice. Therefore, the definitions of these terms should be determined based on the entire content of this specification.

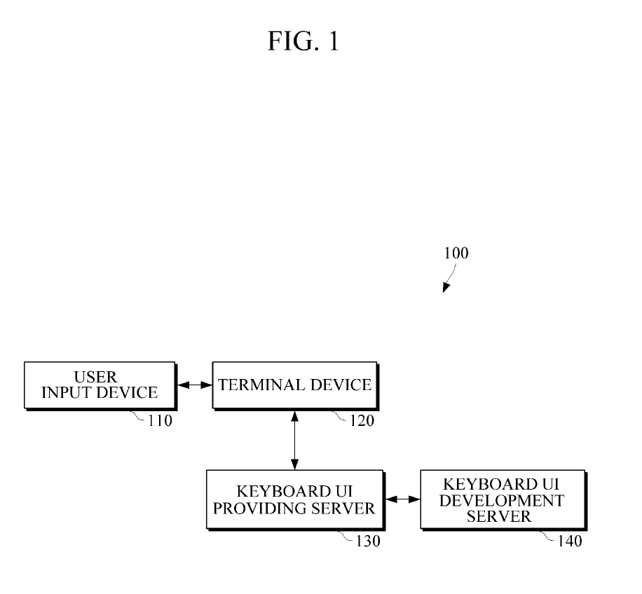

FIG. 1 is a diagram illustrating the configuration of a system for providing a customized keyboard user interface (UI) according to an embodiment of the present invention.

The system 100 for providing a customized keyboard UI may include a user input device 110, a terminal device 120, a keyboard user interface (UI) providing server 130, and a keyboard UI development server 140.

The user input device 110 is a touch screen user input device which provides a customized UI for each individual user, so that users, for example, users with various types of disabilities can use the touch screen user input device according to an embodiment of the present invention.

The terminal device 120 is a user terminal device which receives a user input signal through the user input device 110 and operates according to the user input signal. The terminal device 120 may be one of various forms of electronic devices including a desktop computer, a laptop computer, a tablet computer, and a smart television. The terminal device 120 is configured to communicate with the user input device 110 and the keyboard UI providing server 130.

The keyboard UI providing server 130 provides a customized keyboard UI to each user through a network. The keyboard UI providing server 130 is configured to provide a keyboard UI desired by each user.

The terminal device 120 may generate key UI request information for requesting keyboard UI data that is to be set in the user input device 110 and transmit the keyboard UI request information to the keyboard UI providing server 130. The keyboard UI request information is used by the keyboard UI providing server 130 to select a keyboard UI suitable for a user of the terminal device 120. The keyboard UI request information may include user identifier information.

The terminal device 120 receives keyboard UI data determined based on the keyboard UI request information from the keyboard UI providing server 130. The terminal device 120 may set the received keyboard UI data in the user input device 110.

The keyboard UI development server 140 provides development tools for developing a customized UI. A customized keyboard UI developer can develop a customized keyboard UI using the keyboard UI development server 140. Developed keyboard UI data is registered and managed by the keyboard UI providing server 130.

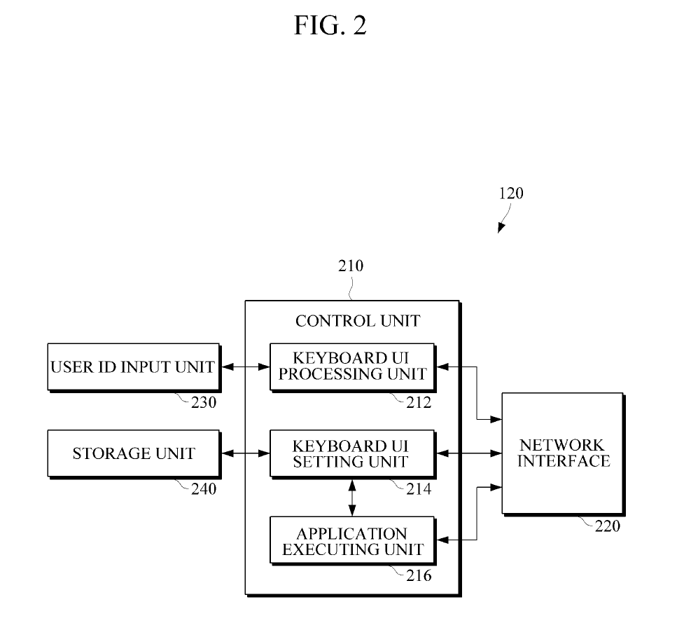

FIG. 2 is a block diagram illustrating an example configuration of the terminal device 120 to which the user input device 110 of FIG. 1 is connected.

The terminal device 120 may include a control unit 210, a network interface 220, a user ID input unit 230, and a storage unit 240.

The control unit 210 may control the overall operation of the terminal device 120. The control unit 210 may include a keyboard UI processing unit 212, a keyboard UI setting unit 214, and an application executing unit 216. The keyboard UI processing unit 212 and the keyboard UI setting unit 214 can be configured as one keyboard manager module which controls operations related to keyboard UI data that is provided to the user input device 110.

The keyboard UI processing unit 212 generates keyboard UI request information for requesting keyboard UI data that is to be set in the user input device 110. The keyboard UI processing unit 212 receives user identification information and generates keyboard UI request information which includes the received user identification information. The user identification information may include at least one of biometric information, an authentication certificate, letters, and numbers.

The keyboard UI setting unit 214 receives keyboard UI data from the keyboard UI providing server 130 through the network interface 220 and sets the received keyboard UI data in the user input device 110. The keyboard UI data may include a keyboard UI identifier, key position information, key meaning information, and key property information indicating display properties of each key. The key property information may include an image of each key. The keyboard UI data may further include identification information of an application that uses a keyboard UI corresponding to the keyboard UI data.

The application executing unit 216 executes an operating system and applications of the terminal device 120. When the user input device 110 inputs a key value based on keyboard UI data, the application executing unit 216 executes an application by processing the key value. The application execution unit 216 may manage an identifier of a currently running application and transmit the identifier of the currently running application to the keyboard UI setting unit 214 at the request of the keyboard UI setting unit 214.

When receiving a plurality of different keyboard UI data corresponding to keyboard UI request information from the keyboard UI providing server 130, the keyboard UI setting unit 213 may identify identification information of an application currently being executed by the application executing unit 216, determine keyboard UI data which includes the identification information of the application as keyboard UI data to be provided to the terminal device 120, and set the determined keyboard UI data in the user input device 110.

When receiving a plurality of different keyboard UI data corresponding to keyboard UI request information from the keyboard UI providing server 130, the keyboard UI setting unit 214 may determine one of the received keyboard UI data as keyboard UI data to be set in the terminal device 120 and set selection key information for switching to keyboard Uls excluding set keyboard UI data from the received keyboard UI data in the user input device 110, together with the determined keyboard UI data. When a user selects the selection menu to change the set keyboard UI data using the user input device 110, the keyboard UI setting unit 214 may set other keyboard UI data usable by the user in the user input device 110.

The network interface 220 communicates with the keyboard UI providing server 130 and the user input device 110 through the network. To this end, the network interface 220 may include a first network interface (not shown) which communicates with the keyboard UI providing server 130 and a second network interface (not shown) which communicates with the user input device 110. The network interface 220 transmits keyboard UI request information to the keyboard UI providing server 130 and receives keyboard UI data determined based on the keyboard UI request information from the keyboard UI providing server 130.

The user ID input unit 230 receives user identification information and transmits the received user identification information to the keyboard UI processing unit 212. The user identification information may include at least one of biometric information, an authentication certificate, letters, and numbers. The user ID input unit 230 may be a connection module that connects a universal serial bus (USB) card for receiving an authentication certificate to the terminal device 120. The user ID input unit 230 may include a biometric sensor for obtaining biometric information such as fingerprints and iris. The user ID input unit 230 may include various components according to the type of user ID.

Alternatively, the user ID input unit 230 may receive a keyboard UI identifier for identifying keyboard UI data, instead of user identification information. Here, the keyboard UI identifier may be information generated as a UI is registered or selected. In this case, the keyboard UI processing unit 212 may generate keyboard UI request information which includes the keyboard UI identifier, transmit the generated keyboard UI request information to the keyboard UI providing server 130, and receive keyboard UI data corresponding to the transmitted keyboard UI identifier from the keyboard UI providing server 130.

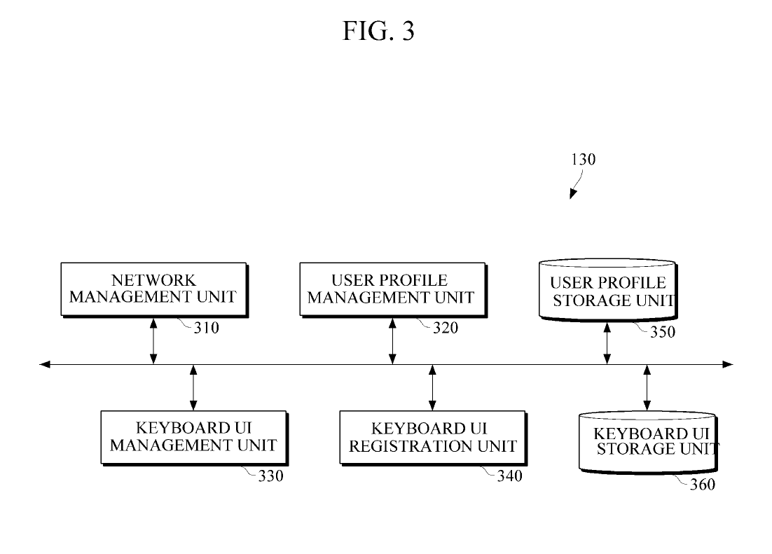

FIG. 3 is a block diagram illustrating an example configuration of the keyboard UI providing server 130 of FIG. 1.

The keyboard UI providing server 130 may include a network management unit 310, a user profile management unit 320, a keyboard UI management unit 330, a keyboard UI registration unit 340, a user profile storage unit 350, and a keyboard UI storage unit 360.

The network management unit 310 is responsible for communication in order to provide a UI to the terminal device 120 through the network. In addition, the network management unit 310 communicates with the keyboard UI development server 140 to receive a new UI developed using a customized keyboard UI development toolkit from the keyboard UI development server 140.

The user profile management unit 320 manages profile information about various users. User profile information may include an identifier of each user and an identifier of at least one keyboard UI desired by each user. The user profile storage unit 350 stores the user profile information.

The keyboard UI management unit 330 authenticates and manages users. The keyboard UI management unit 330 selects keyboard UI data, which is to be sent to the terminal device 120, from a plurality of keyboard UI data based on keyboard UI request information (including user identification information) received from the terminal device 120 and using a user profile. In detail, the keyboard UI management unit 330 may request the user profile management unit 320 to provide identification information of a keyboard UI desired by a user corresponding to a user identifier, receive the identification information of the keyboard UI from the user profile management unit 320, and transmit keyboard UI data corresponding to the received identification information to the terminal device 120 through the network management unit 310.

The keyboard UI management unit 330 may manage a plurality of keyboard UI data. In particular, the keyboard UI management unit 330 may offer integrity in the management of the keyboard UI data. In detail, the keyboard UI management unit 330 may check and manage overlapping keyboard UI data or unusable keyboard UI data. The keyboard UI management unit 330 stores keyboard UI data, whose integrity has been verified, in the keyboard UI storage unit 360.

The keyboard UI registration unit 340 registers keyboard UI data developed by a developer using the keyboard UI development server 140. The keyboard UI registration unit 340 enables the keyboard UI data created by the keyboard UI developer to be uploaded to the keyboard UI storage unit 360 of the UI providing server 130. When new keyboard UI data created by a UI developer is registered, the keyboard UI registration unit 340 may generate a keyboard UI identifier for identifying the registered keyboard UI data. The keyboard UI identifier may be stored in the keyboard UI storage unit 360 together with the registered keyboard UI data and managed by the keyboard UI management unit 330.

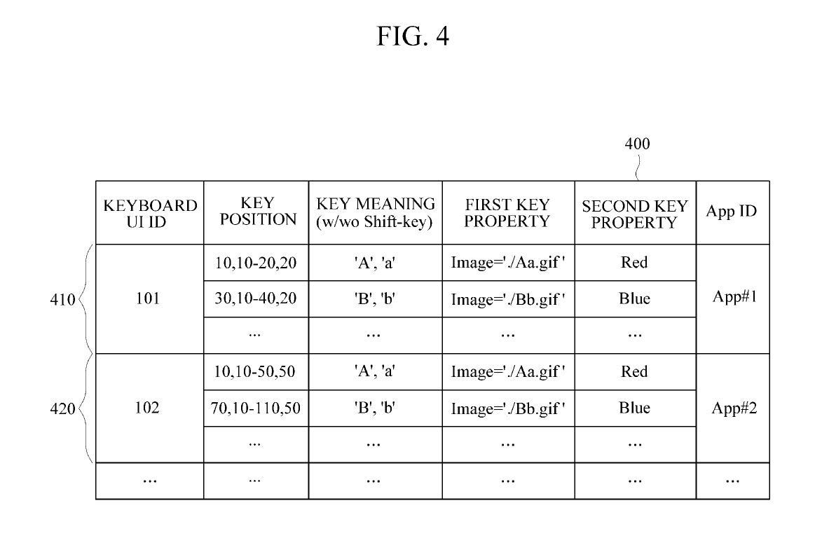

FIG. 4 is a diagram illustrating an example configuration of keyboard UI data stored in the keyboard UI storage unit 360 of the keyboard UI providing server 130 of FIG. 3.

The keyboard UI storage unit 360 stores various forms of keyboard UI data. Each keyboard UI data is identified by a keyboard UI identifier. Each keyboard UI data may include key position information indicating the position of each of a plurality of keys on a keyboard UI, key meaning information describing the meaning of each key, and key property information related to a method of displaying each key. The key position information, the key meaning information, and the key property information are defined for each of a plurality of keys provided in one keyboard UI data. The key property information may include an image of each key. In addition, the key property information may include background color information of each key. Multiple pieces of key property information can be provided for one key as long as they are related to the display of the key.

Each keyboard UI data may optionally include identification information of an application that uses a keyboard UI corresponding to the keyboard UI data. Application identification information is identification information of an application that mostly or exclusively uses a corresponding keyboard UI. The application identification information is included in and defined for each keyboard UI data.

Referring to FIG. 4, keyboard UI data 410 whose keyboard UI identifier is 101 may include a key whose key position information is [10,10]-[20,20], key meaning information is ‘A’ and ‘a,’ first key property information is “Image='./Aa.gif,” and second key property information is “Red.” In addition, the keyboard UI data may include a key whose key position information is [30,10]-[40,20], key meaning information is ‘B’ and ‘b,’ first key property information is “Image='./Bb.gif,” and second key property information is “Blue.”

The position information of each key in the keyboard UI data 410 may be information indicating a screen range in which a corresponding key is displayed on the screen which displays the keyboard UI data 410. For example, when the entire display area of the user input device 110 which provides the keyboard UI data 410 is represented by a 200×200 grid with a 1×1 unit grid, [10,10]-[20,20] may indicate the positions of vertices of a grid cell occupied by a corresponding key and indicate a rectangular range with vertices at [10,10] and [20,20]. The key meaning information indicates a letter, number or function represented by the corresponding key. When the corresponding key is selected, it is recognized that capital letter “A” is input. When the corresponding key is selected together with a shift key, it is recognized that small letter “a” is input. The first key property information “Image='./Aa.gif” indicates image information of the corresponding key, and the second key property information indicates that an area outside a range indicated by “Image='./Aa.gif” in [10,10]-[20,20], that is, the background screen of [10,10]-[20,20] is red.

The key position information can be used as an identifier of each key, and the keyboard UI data 410 may further include a key identifier of each key.

The keyboard UI data 410 may include an equal number of pieces of the key position information, the key meaning information, the first key property information, and the second key property information to the number of keys. The keyboard UI data 410 may further include identification information “App#1” of an application that uses the keyboard UI data 410.

The keyboard UI data 420 may have the same form as the keyboard UI data 410.

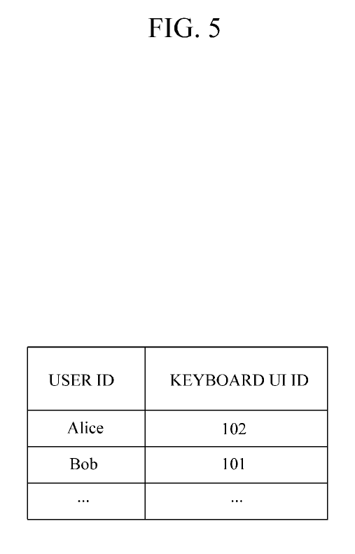

FIG. 5 is a diagram illustrating user profile information managed by the keyboard UI providing server 130 of FIG. 3.

Referring to FIG. 5, the user profile storage unit 350 stores pairs of a user ID and a keyboard UI identifier corresponding to the user ID. Referring to FIG. 5, a keyboard UI identifier corresponding to a user whose user ID is “Alice” may be “102,” and a keyboard UI identifier corresponding to a user whose user ID is “Bob” may be “101.”

In FIG. 5, one keyboard UI identifier is stored for one user ID. However, when a user with one user ID uses a plurality of desired keyboard Uls, the user profile information may configured such that a plurality of keyboard UI identifiers correspond to one user ID. When a plurality of keyboard UI identifiers are found for one user ID included in keyboard UI request information received from the terminal device 120, the keyboard UI providing server 130 may transmit a plurality of keyboard UI data indicated by the keyboard UI identifiers to the terminal device 120.

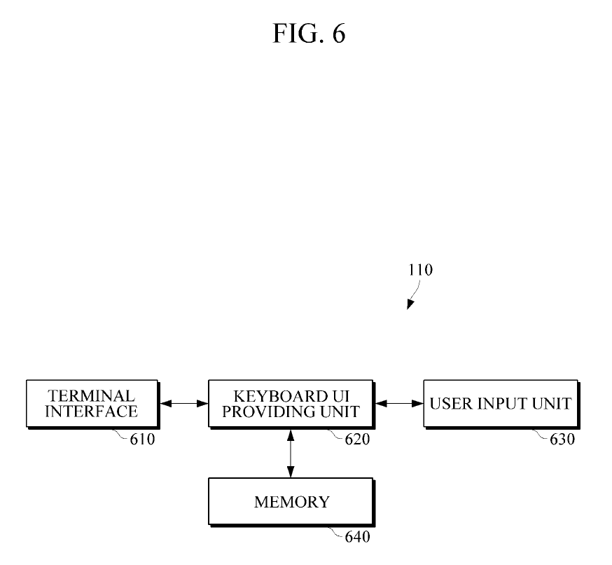

FIG. 6 is a block diagram illustrating an example configuration of the user input device 110 of FIG. 1.

The user input device 110 may be configured as a hardware device which includes a touch screen and a processor. The user input device 110 may include a terminal interface 610, a keyboard UI providing unit 620, a user input unit 630, and a memory 640.

The terminal interface 610 is an interface for connection with the terminal device 120.

The keyboard UI providing unit 620 is configured to drive an embedded operating system which controls the operation of the user input device 110. Thus, the keyboard UI providing unit 620 controls the operations of the terminal interface 610, the user input unit 630 and the memory 640. The keyboard UI providing unit 620 manages a keyboard UI provided to the user input unit 630.

The user input unit 630 is configured as a hardware device which includes a touch screen. The user input unit 630 displays keyboard UI data and receives a user input signal.

The memory 640 stores keyboard UI data received from the keyboard UI providing unit 620. The memory 640 may store one or more keyboard UI data. When a plurality of keyboard UI data are stored in the memory 640, one of the keyboard UI data may be set as basic keyboard UI data and provided to the user input unit 630.

The keyboard UI providing unit 620 receives keyboard UI data from the terminal device 120 through the terminal interface 610 and manages the received keyboard UI data.

As described above, when the terminal device 120 transmits keyboard UI request information to the keyboard UI providing server 130 connected to the terminal device 120, keyboard UI data is determined by the keyboard UI providing server 130 based on the keyboard UI request information and downloaded to the terminal device 120.

The keyboard UI providing unit 620 may scale keyboard UI data to a size that can be displayed by the user input unit 630 and output the scaled keyboard UI data to the user input unit 630. When a user inputs a key value based on a displayed keyboard UI, the keyboard UI providing unit 620 may transmit the input key value to the terminal device 120 through the terminal interface 610.

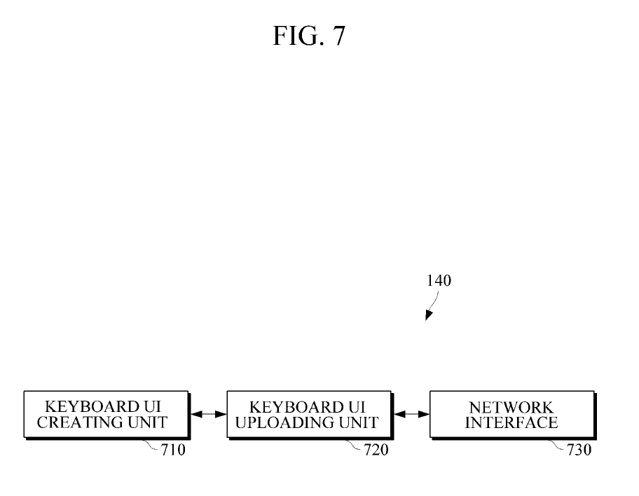

FIG. 7 is a block diagram illustrating an example configuration of the keyboard UI development server 140 of FIG. 1.

The keyboard UI development server 140 may include a keyboard UI creating unit 710, a keyboard UI uploading unit 720, and a network interface 730.

The keyboard UI creating unit 710 provides a library based on which a developer can easily create keyboard UI data through logical scaling. The keyboard UI uploading unit 720 uploads developed keyboard UI data to the keyboard UI providing server 130. The network interface 730 is responsible for network communication with the keyboard UI providing server 130.

A keyboard UI developer may design a desired keyboard arrangement in various forms (such as GUI and text forms) by utilizing the library of the keyboard UI creating unit 710 and create a logical keyboard map UI. The logical keyboard map UI may configured as keyboard data set information which includes a keyboard UI identifier and the position, meaning and other properties of each key, as described above with reference to FIG. 4.

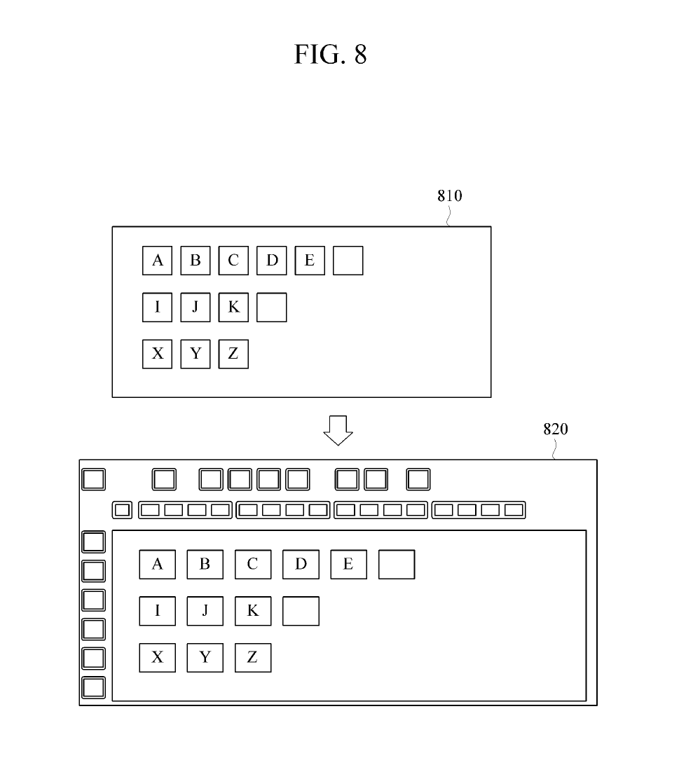

FIG. 8 is a diagram illustrating a keyboard UI corresponding to keyboard UI data received by the terminal device 120 from the keyboard UI providing server 130 and a keyboard UI displayed on the user input device 110 according to an embodiment of the present invention.

Keyboard UI data developed by a UI developer should be mapped to the display screens implementing different physical keyboard devices. Keyboard UI data transmitted from the keyboard UI providing server 130 to the terminal device 120 can be referred to as a logical keyboard map UI. The logical keyboard map UI may be scaled to the size of the actual display screen by the user input device 110 and provided accordingly.

Referring to FIG. 8, a keyboard UI 810 is a logical keyboard map UI, and a keyboard UI 820 is a UI scaled to the size of a display of the user input unit 630 of the user input device 110 and provided on the actual display screen.

The keyboard UI setting unit 230 of the terminal 120 or the keyboard UI providing unit 620 of the user input device 110 may include additional UI information in a logical keyboard map UI and provide a user keyboard UI that is to be actually displayed. The additional UI information is not included in the logical keyboard map UI on the keyboard screen. The additional UI information may be UI screen information provided basically, icon information used to receive a keyboard UI selection signal, or the like. In FIG. 8, keys on the keyboard UIs 810 and 820 are shown in black and have the same size and shape. However, each key may have a different size, shape and color according to the key property information set for the key.

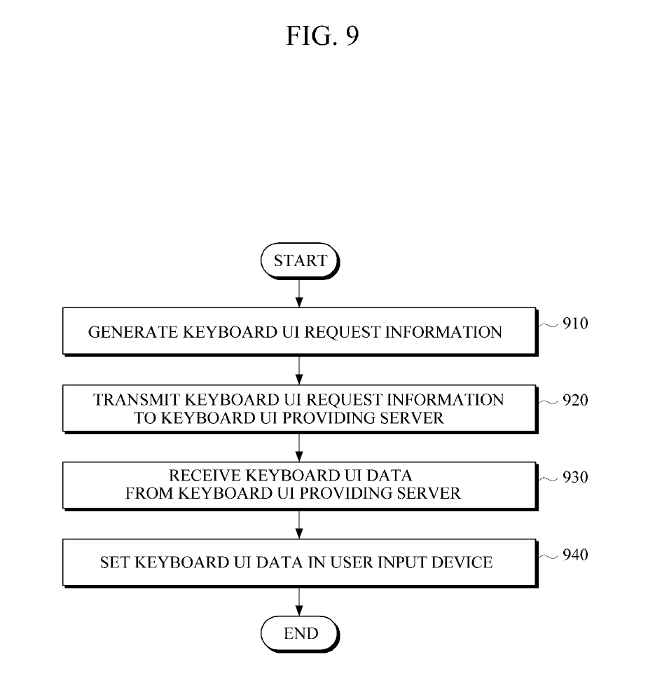

FIG. 9 is a flowchart illustrating a keyboard UI providing method of the terminal device 120 which provides a customized keyboard UI according to an embodiment of the present invention.

The terminal device 120 generates keyboard UI request information for requesting keyboard UI data that is to be set in the user input device 110 (operation 900). The keyboard UI request information may include user identification information.

The terminal device 120 transmits the keyboard UI request information to the keyboard UI providing server 130 (operation 920).

The terminal 120 receives keyboard UI data corresponding to the keyboard UI request information from the keyboard UI providing server 130 (operation 930). The keyboard UI data corresponding to the keyboard UI request information may be selected by the keyboard UI providing server 130 and may include keyboard UI identification information corresponding to the user identification information included in the keyboard UI request information of the terminal device 120.

The terminal device 120 sets the received keyboard UI data in the user input device 110 (operation 940).

When receiving a plurality of different keyboard UI data corresponding to the keyboard UI request information from the keyboard UI providing server 130, the terminal device 120 may identify identification information of a currently running application, determine keyboard UI data, which includes the identification information of the currently running application, as keyboard UI data that is to be provided to the terminal device 120, and set the determined keyboard UI data in the user input device 110. When receiving a plurality of different keyboard UI data corresponding to the keyboard UI request information from the keyboard UI providing server 130, the terminal device 120 may determine one of the received keyboard UI data as keyboard UI data to be set in the terminal device 120 and set selection key information for switching to keyboard Uls excluding set keyboard UI data from the received keyboard UI data in the user input device 110, together with the determined keyboard UI data.

According to the present invention, there is no need to manufacture a special keyboard for each disabled user, unlike a conventional keyboard manufactured for each disabled user. Instead, a different letter arrangement UI can be provided on a common keyboard platform according to the degree of disability of each user. Therefore, since a common product group, not a special keyboard product, can be provided to users with various disabilities, mass production is possible, thus reducing manufacturing costs of terminals.

Furthermore, a disabled user can use a public PC without carrying his or her own keyboard. When a difference occurs between previous disability information and current disability information due to the aggravation or improvement of the disability of the user, the user can simply select a suitable software keyboard UI arrangement without changing hardware. Therefore, the disabled can select and use an information technology (IT) environment optimized for them. Not only physically disabled people but also foreigners who use different languages can be provided with keyboard arrangements suitable for their languages in PC rooms and public institutions.

The present invention can also be used as a family PC for multicultural families. Since the present invention provides an input environment suitable for children who use the same PC as adults, it can be used for early education. Moreover, people (such as gamers and accountants) doing special jobs for which a general keyboard arrangement is not suitable can dynamically change a keyboard UI optimized for their work environment, thereby improving their work productivity.

According to the present invention, it is possible to provide a customized keyboard UI for each individual user using a common keyboard device. In particular, there is no need to manufacture a special keyboard for each disabled user, unlike a conventional keyboard manufactured for each disabled user. Instead, a different letter arrangement UI can be provided on a common keyboard platform according to the degree of disability of each user. Therefore, since a common product group, not a special keyboard product, can be provided to users with various disabilities, mass production is possible, thus reducing manufacturing costs of terminals.

The current embodiments can be implemented as computer readable codes in a computer readable record medium. Codes and code segments constituting the computer program can be easily inferred by a skilled computer programmer in the art. The computer readable record medium includes all types of record media in which computer readable data are stored. Examples of the computer readable record medium include a ROM, a RAM, a CD-ROM, a magnetic tape, a floppy disk, and an optical data storage. Further, the record medium may be implemented in the form of a carrier wave such as Internet transmission. In addition, the computer readable record medium may be distributed to computer systems over a network, in which computer readable codes may be stored and executed in a distributed manner.

While this invention has been particularly shown and described with reference to exemplary embodiments thereof, it will be understood by those skilled in the art that various changes in form and details may be made therein without departing from the spirit and scope of the invention as defined by the appended claims. Therefore, the scope of the invention is defined not by the examples given but by the patent claims and their legal equivalents.

What is claimed is:

1. A terminal device comprising:
a keyboard user interface (UI) processing unit generating keyboard UI request information for requesting keyboard UI data which is to be set in a user input device;
a network interface unit communicating with a keyboard UI providing server and the user input device, transmitting the keyboard UI request information to the keyboard UI providing server, and receiving keyboard UI data determined based on the keyboard UI request information from the keyboard UI providing server; and
a keyboard UI setting unit setting the received keyboard UI data in the user input device.

2. The terminal device of claim 1, wherein the keyboard UI processing unit receives user identification information and generates the keyboard UI request information which comprises the received user identification information.

3. The terminal device of claim 2, wherein the user identification information comprises at least one of biometric information, an authentication certificate, letters, and numbers.

4. The terminal device of claim 2, further comprising a user ID input unit receiving the user identification information and transmitting the received user identification information to the keyboard UI processing unit.

5. The terminal device of claim 1, further comprising an application executing unit executing an application by processing a key value input from the user input device based on the keyboard UI data.

6. The terminal device of claim 1, wherein the keyboard UI data comprises a keyboard UI identifier, key position information, key meaning information, and key property information indicating display properties of each key.

7. The terminal device of claim 6, wherein the key property information comprises an image of each key.

8. The terminal device of claim 6, wherein the keyboard UI data further comprises identification information of an application which uses a keyboard UI corresponding to the keyboard UI data, and when receiving a plurality of different keyboard UI data corresponding to the keyboard UI request information from the keyboard UI providing server, the keyboard UI setting unit identifies identification information of an application currently being executed by the application executing unit and determines keyboard UI data which comprises the identification information of the application as keyboard UI data to be provided to the terminal device.

9. The terminal device of claim 1, wherein when receiving a plurality of different keyboard UI data corresponding to the keyboard UI request information from the keyboard UI providing server, the keyboard UI setting unit determines one of the received keyboard UI data as keyboard UI data to be set in the terminal device and sets selection key information for switching to keyboard Uls excluding set keyboard UI data from the received keyboard UI data in the user input device, together with the determined keyboard UI data.

10. The terminal device of claim 1, further comprising the user input device communicating with the terminal device, wherein the user input device comprises:
a terminal interface configured to communicate with the terminal device;
a keyboard UI providing unit receiving keyboard UI data from the terminal device through the terminal interface and managing the keyboard UI data; and
a user input unit displaying the keyboard UI data and receiving a user input signal,
wherein the keyboard UI data is determined by the keyboard UI providing server based on the keyboard UI request information transmitted from the terminal device to the keyboard UI providing server connected to the terminal device and downloaded to the terminal device.

11. The terminal device of claim 10, wherein the keyboard UI providing unit scales the keyboard UI data to a size which can be displayed by the user input unit and outputs the scaled keyboard UI data to the user input unit.

12. The terminal device of claim 10, wherein the keyboard UI providing unit transmits a key value input based on a displayed keyboard UI to the terminal device through the terminal interface.

13. A keyboard UI providing server comprising:
a keyboard UI storage unit storing a plurality of keyboard UI data;
a user profile management unit managing a user profile which indicates keyboard UI identification information corresponding to user identification information of each of a plurality of users;
a keyboard UI management unit selecting keyboard UI data, which is to be sent to a terminal device, from the keyboard UI data based on keyboard UI request information received from the terminal device and using the user profile; and
a network management unit transmitting the selected keyboard UI data through a network,
wherein the keyboard UI request information comprises the user identification information.

14. The server of claim 13, further comprising a user profile storage unit storing at least one piece of the keyboard UI identification information corresponding to the user identification information of each of the users.

15. The server of claim 13, further comprising a keyboard UI registration unit connected to a keyboard UI development server and registering keyboard UI data received from the keyboard UI development server.

16. A keyboard UI providing method of a terminal device which is connected to a keyboard UI providing server and a user input device through a network, the method comprising:
generating keyboard UI request information for requesting keyboard UI data which is to be set in the user input device;
transmitting the keyboard UI request information to the keyboard UI providing server;
receiving keyboard UI data corresponding to the keyboard UI request information from the keyboard UI providing server; and
setting the received keyboard UI data in the user input device.

17. The method of claim 16, wherein in the generating of the keyboard UI request information, keyboard UI request information which comprises input user identification information is generated.

18. The method of claim 16, wherein the keyboard UI data comprises a keyboard UI identifier, key position information, key meaning information, and key property information indicating display properties of each key.

19. The method of claim 16, wherein the keyboard UI data corresponding to the keyboard UI request information is selected by the keyboard UI providing server and comprises keyboard UI identification information corresponding to the user identification information included in the keyboard UI request information of the terminal device.

20. The method of claim 18, wherein the keyboard UI data further comprises identification information of an application which uses a keyboard UI corresponding to the keyboard UI data and further comprising, when receiving a plurality of different keyboard UI data corresponding to the keyboard UI request information from the keyboard UI providing server, identifying identification information of a currently running application and determining keyboard UI data which comprises the identification information of the application as keyboard UI data to be provided to the terminal device.
